(19) United States
(12) Patent Application Publication
(10) Pub. No.: US 2025/0360560 A1
(43) Pub. Date: Nov. 27, 2025

(54) HYDROGEN DECREPITATION APPARATUSES AND HYDROGEN RECYCLING METHODS

(71) Applicant: BAOTOU RESEARCH INSTITUTE OF RARE EARTHS, Baotou (CN)

(72) Inventors: Li Wang, Baotou (CN); Jin Li, Baotou (CN); Xu Zhang, Baotou (CN); Yuyuan Zhao, Baotou (CN); Zhihong Yu, Baotou (CN); Hongyuan Han, Baotou (CN); Jin Bai, Baotou (CN); Shujuan Zhou, Baotou (CN); Qianwen Liu, Baotou (CN); Xuejiao Hu, Baotou (CN); Jin Xu, Baotou (CN); Baoquan Li, Baotou (CN)

(73) Assignee: BAOTOU RESEARCH INSTITUTE OF RARE EARTHS, Baotou (CN)

(21) Appl. No.: 19/292,496

(22) Filed: Aug. 6, 2025

(30) Foreign Application Priority Data
Apr. 22, 2025 (CN) 202510508871.2

(51) Int. Cl. B22F 9/02

(52) U.S. Cl. CPC B22F 9/023; B22F 2201/10; B22F 2203/13; B22F 2301/355

(57) ABSTRACT

The present disclosure provides a hydrogen decrepitation apparatus and a hydrogen recycling method. The hydrogen decrepitation apparatus comprises a hydrogen decrepitation furnace, a solid hydrogen-storage device, a first hydrogen recovery pipeline, a second hydrogen recovery pipeline, a hydrogen reuse pipeline, a first discharge pipe, a second discharge pipe, an inert gas pipeline, and a bypass pipeline. The hydrogen decrepitation apparatus enables hydrogen used in hydrogen decrepitation to be reused, thereby reducing costs of hydrogen decrepitation and lowering energy waste.

### TECHNICAL FIELD OF THE DISCLOSURE

The present disclosure relates to a hydrogen decrepitation apparatus and a hydrogen recycling method.

### BACKGROUND OF THE DISCLOSURE

Hydrogen decrepitation uses the difference between the Nd₂Fe₁₇B phase and the Nd-rich phase in hydrogen absorption rate, thereby generating stress at the boundary between the Nd₂Fe₁₇B phase and the Nd-rich phase and resulting in micro-cracks. These micro-cracks enable neodymium-iron-boron flakes to be easily jet-milled to a grain size falling within the desired range. Hydrogen decrepitation is a crucial process in magnet production, as it enhances the magnetic properties of magnet. Hydrogen decrepitation primarily comprises the two steps of hydrogen absorption and hydrogen desorption. During the desorption step, hydrogen is released into the atmosphere, resulting in significant energy waste.

CN117051432A discloses a control system integrating hydrogen production by water electrolysis with hydrogen storage with alloys, comprising an assembly for hydrogen production by water electrolysis and an ultrasonic detector. The assembly for hydrogen production by water electrolysis is connected to a first hydrogen pipe connected to a safety tank. The safety tank is connected, on a side thereof that is away from the first hydrogen pipe, to a second hydrogen pipe. The second hydrogen pipe is connected, on a side thereof that is away from the safety tank, to a hydrogen storage tank. The hydrogen storage tank is filled with a hydrogen storage alloy. The safety tank is equipped with a current cathode-protection assembly, the positive terminal of which is grounded. The safety tank is equipped with an ultrasonic leak detector. This apparatus is used for storing hydrogen produced by water electrolysis.

CN119146347A discloses a high-pressure hydrogen charging system for samples for impact resistance testing on metals, comprising a sample hydrogen-charging vessel, a high-pressure recovery vessel, a low-pressure recovery vessel, a waste gas tank, a first manual valve, a second manual valve, a third manual valve, a fourth manual valve, a pressure reduction valve, a fifth manual valve, a sixth manual valve, a seventh manual valve, a pressure monitor, and a hydrogen purity monitor, which are interconnected via pipes. The first manual valve, the waste gas tank, the second manual valve, the third manual valve, the sample hydrogen-charging vessel, and the fourth manual valve are connected to each other in this order. The fifth manual valve, the low-pressure recovery vessel, the sixth manual valve, the seventh manual valve, and the high-pressure recovery vessel are connected to each other in this order. The pressure reduction valve is bridged between the second manual valve and the sixth manual valve. The pressure monitor is configured to monitor the system pressure, and the hydrogen purity monitor is configured to monitor the hydrogen purity in the pipes. This apparatus, by recovering hydrogen with the high-pressure and low-pressure recovery vessels, are large in size and low in safety.

### SUMMARY OF THE DISCLOSURE

In view of the above, one objective of the present disclosure is to provide a hydrogen decrepitation apparatus that enables hydrogen used in hydrogen decrepitation to be reused, reducing costs of hydrogen decrepitation and lowering energy waste. Furthermore, the hydrogen decrepitation apparatus of the present disclosure exhibits high safety. Another objective of the present disclosure is to provide a hydrogen recycling method using the above hydrogen decrepitation apparatus.

The present disclosure accomplishes the above objectives by technical solutions described below.

One aspect of the present disclosure is to provide a hydrogen decrepitation apparatus, comprising a hydrogen decrepitation furnace, a solid hydrogen-storage device, a first hydrogen recovery pipeline, a second hydrogen recovery pipeline, a hydrogen reuse pipeline, a first discharge pipe, a second discharge pipe, an inert gas pipeline, and a bypass pipeline,
the hydrogen decrepitation furnace is provided with a hydrogen decrepitation furnace port configured to allow a gas to enter or exit the hydrogen decrepitation furnace;
the solid hydrogen-storage device is provided with a solid hydrogen-storage device port configured to allow hydrogen to enter or exit the solid hydrogen-storage device;
the first hydrogen recovery pipeline comprises a first end and a second end away from the first end, wherein the first end of the first hydrogen recovery pipeline is connected to the hydrogen decrepitation furnace port, and the second end of the first hydrogen recovery pipeline is connected to the solid hydrogen-storage device port;
the inert gas pipeline comprises a first end and a second end away from the first end, wherein the first end of the inert gas pipeline is connected to the first hydrogen recovery pipeline, and the second end of the inert gas pipeline is configured to connect to an inert gas supply device;
the first discharge pipe comprises a first end and a second end away from the first end, wherein the first end of the first discharge pipe is connected to the first hydrogen recovery pipeline, and the second end of the first discharge pipe is a free end;
the second hydrogen recovery pipeline comprises a first end and a second end away from the first end, wherein the first end of the second hydrogen recovery pipeline is connected to the first hydrogen recovery pipeline, the second end of the second hydrogen recovery pipeline is connected to the first hydrogen recovery pipeline, and a point where the first end of the second hydrogen recovery pipeline intersects the first hydrogen recovery pipeline is located between the first end of the first hydrogen recovery pipeline and a point where the second end of the second hydrogen recovery pipeline intersects the first hydrogen recovery pipeline; and the second hydrogen recovery pipeline is provided, in a direction from the first end to the second end, with a Roots pump and a screw pump in this order;
the second discharge pipe comprises a first end and a second end away from the first end, wherein the first end of the second discharge pipe is connected to the second hydrogen recovery pipeline located between the screw pump and the second end of the second hydrogen recovery pipeline, and the second end of the second discharge pipe is a free end;
a first end of the bypass pipeline is connected to the second hydrogen recovery pipeline located between the screw pump and a point where the first end of the second discharge pipe intersects the second hydrogen recovery pipeline, and a second end of the bypass pipeline is connected to the second discharge pipe; the bypass pipeline is provided with a vacuum pump configured to discharge a gas in at least a portion of the second hydrogen recovery pipeline and a gas in at least a portion of the second discharge pipe; and
one end of the hydrogen reuse pipeline is connectable to the hydrogen decrepitation furnace port, and another end of the hydrogen reuse pipeline is connectable to the solid hydrogen-storage device port; the hydrogen reuse pipeline is configured to convey hydrogen from the solid hydrogen-storage device to the hydrogen decrepitation furnace.

In the hydrogen decrepitation apparatus according to the present disclosure, preferably, the first hydrogen recovery pipeline is provided, in a direction from the first end to the second end, with a first valve, a first pressure detection device, a flow meter, and a fourth valve in this order,
wherein the first valve is arranged near the hydrogen decrepitation furnace port;
the first pressure detection device is configured to detect a pressure inside the hydrogen decrepitation furnace;
the flow meter is configured to measure the amount of hydrogen passing through a pipeline between the hydrogen decrepitation furnace and the solid hydrogen-storage device; and
the fourth valve is configured to control a gas in the first hydrogen recovery pipeline such that it flows toward the solid hydrogen-storage device.

In the hydrogen decrepitation apparatus according to the present disclosure, preferably, the first hydrogen recovery pipeline is further provided with a second valve arranged between the first pressure detection device and the flow meter,
wherein the first end of the second hydrogen recovery pipeline is connected to the first hydrogen recovery pipeline located between the first pressure detection device and the second valve, and the second end of the second hydrogen recovery pipeline is connected to the first hydrogen recovery pipeline located between the second valve and the flow meter; and
the second hydrogen recovery pipeline is provided with a fifth valve and a sixth valve,
wherein the fifth valve is arranged between the first end of the second hydrogen recovery pipeline and the Roots pump, and
the sixth valve is arranged between the screw pump and the second end of the second hydrogen recovery pipeline.

In the hydrogen decrepitation apparatus according to the present disclosure, preferably, the hydrogen reuse pipeline comprises a first hydrogen reuse pipeline and a second hydrogen reuse pipeline,
wherein a first end of the first hydrogen reuse pipeline is connected to the first hydrogen recovery pipeline located between the second valve and the flow meter, and a second end of the first hydrogen reuse pipeline is connected to the solid hydrogen-storage device port; and
a first end of the second hydrogen reuse pipeline is connected to the first hydrogen recovery pipeline located between the first pressure detection device and the second valve, and a second end of the second hydrogen reuse pipeline is connected to the first hydrogen recovery pipeline located between the flow meter and the fourth valve.

In the hydrogen decrepitation apparatus according to the present disclosure, preferably, the first end of the second discharge pipe is connected to the second hydrogen recovery pipeline located between the screw pump and the sixth valve;
the second discharge pipe is provided with a tenth valve,
wherein the second end of the bypass pipeline is connected to the second discharge pipe between the tenth valve and the second end of the second discharge pipe; and
the bypass pipeline is provided with an eleventh valve arranged between the vacuum pump and the first end of the bypass pipeline.

In the hydrogen decrepitation apparatus according to the present disclosure, preferably, the first hydrogen reuse pipeline is provided, from the first end to the second end, with a seventh valve, a pressure reduction valve, and a second pressure detection device in this order,
wherein the pressure reduction valve is configured to reduce a pressure of hydrogen released from the solid hydrogen-storage device;
the second pressure detection device is configured to detect a pressure inside the solid hydrogen-storage device; and
the second hydrogen reuse pipeline is provided with an eighth valve arranged close to the first end of the second hydrogen reuse pipeline.

Preferably, the hydrogen decrepitation apparatus according to the present disclosure further comprises an external hydrogen pipeline,
wherein the external hydrogen pipeline comprises a first end and a second end away from the first end, wherein the first end of the external hydrogen pipeline is connected to the second hydrogen reuse pipeline located between the eighth valve and the second end of the second hydrogen reuse pipeline, and the second end of the external hydrogen pipeline is configured to connect to a hydrogen supply device; and
the second hydrogen reuse pipeline is provided with a ninth valve arranged between a point where the first end of the external hydrogen pipeline intersects the second hydrogen reuse pipeline and the second end of the second hydrogen reuse pipeline.

In the hydrogen decrepitation apparatus according to the present disclosure, preferably, the first end of the inert gas pipeline is connected to the first hydrogen recovery pipeline located between the first pressure detection device and a point where the first end of the second hydrogen recovery pipeline intersects the first hydrogen recovery pipeline; the inert gas pipeline is provided with a fourteenth valve; and
the external hydrogen pipeline is provided with a thirteenth valve.

Preferably, the hydrogen decrepitation apparatus according to the present disclosure further comprises: a liquid heat-exchange device, wherein the solid hydrogen-storage device is further provided with a circulation liquid inlet and a circulation liquid outlet; and
the liquid heat-exchange device comprises a first storage tank, a second storage tank, a heat exchanger, a first liquid input pipeline, a second liquid input pipeline, a liquid output pipeline, a first connection pipeline, and a second connection pipeline,
wherein the second storage tank is configured to store a endothermic liquid and provided with a second storage tank inlet and a second storage tank outlet,
the heat exchanger is provided with a heat source inlet, a cold source inlet, a cold source outlet, and a heat source outlet, wherein the cold source inlet is configured to allow an external coolant to enter the heat exchanger, the heat source inlet is configured to allow the endothermic liquid having absorbed heat in the solid hydrogen-storage device to enter the heat exchanger, the heat source outlet is configured to discharge the endothermic liquid subjected to heat exchange in the heat exchanger from the heat exchanger, and the cold source outlet is configured to discharge the coolant subjected to heat exchange from the heat exchanger,
the first liquid input pipeline comprises a first end and a second end spaced away from the first end, wherein the first end of the first liquid input pipeline is connected to the circulation liquid inlet, and the second end of the first liquid input pipeline is connected to the second storage tank outlet,
the second liquid input pipeline comprises a first end and a second end away from the first end, wherein the first end of the second liquid input pipeline is connected to the second storage tank inlet, and the second end of the second liquid input pipeline is connected to the heat source outlet of the heat exchanger,
the liquid output pipeline comprises a first end and a second end away from the first end, wherein the first end of the liquid output pipeline is connected to the circulation liquid outlet, and the second end of the liquid output pipeline is connected to the heat source inlet of the heat exchanger,
the first storage tank comprises a first storage tank body and a heating device, wherein the first storage tank body is configured to store a heat supply liquid and provided with a first storage tank inlet and a first storage tank outlet, and the heating device is configured to heat the heat supply liquid in the first storage tank body,
the first connection pipeline comprises a first end and a second end away from the first end, wherein the first end of the first connection pipeline is connected to the first storage tank outlet, and the second end of the first connection pipeline is connected to the first liquid input pipeline, and
the second connection pipeline comprises a first end and a second end away from the first end, wherein the first end of the second connection pipeline is connected to the first storage tank inlet, and the second end of the second connection pipeline is connected to the liquid output pipeline.

Another aspect of the present disclosure is to provide a hydrogen recycling method using the hydrogen decrepitation apparatus described above, comprising:
(1) opening the fourteenth valve and the first valve to allow an inert gas to enter the hydrogen decrepitation furnace through the inert gas pipeline after placing a hydrogen decrepitation material in the hydrogen decrepitation furnace, closing the fourteenth valve to stop charging the hydrogen decrepitation furnace with the inert gas when the pressure inside the hydrogen decrepitation furnace is P+10 kPa to P+30 kPa, and determining whether the hydrogen decrepitation furnace leaks using the first pressure detection device;
opening the twelfth valve to discharge the gas in the hydrogen decrepitation furnace through the first hydrogen recovery pipeline and the first discharge pipe if it is determined that the hydrogen decrepitation furnace does not leak, and when the pressure inside the hydrogen decrepitation furnace is P, closing the twelfth valve and opening the fifth valve, the Roots pump, the screw pump, and tenth valve to discharge the remained gas in the hydrogen decrepitation furnace through the second discharge pipe until the pressure inside the hydrogen decrepitation furnace is ≤1.5 Pa; and
closing the fifth valve, the Roots pump, the screw pump, and the tenth valve and opening the eleventh valve and the vacuum pump to discharge the gas in the second hydrogen recovery pipeline located between the screw pump and the sixth valve as well as the gas in the second discharge pipe, and closing the eleventh valve and the vacuum pump;
(2) opening the seventh valve, the third valve, the ninth valve, the eighth valve, and the first valve to allow hydrogen released from the solid hydrogen-storage device to enter the hydrogen decrepitation furnace through the first hydrogen reuse pipeline, the first hydrogen recovery pipeline where the flow meter is located, the second hydrogen reuse pipeline, and the first hydrogen recovery pipeline where the first valve is located; and
detecting the pressure inside the hydrogen decrepitation furnace using the first pressure detection device, and repeating the following process until the pressure inside the hydrogen decrepitation furnace stabilizes at P+50 kPa to P+120 kPa, to complete hydrogen charge: closing the eighth valve to stop charging the hydrogen decrepitation furnace with hydrogen when the pressure inside the hydrogen decrepitation furnace is ≥P+80 kPa, and opening the eighth valve to charge the hydrogen decrepitation furnace with hydrogen when the pressure inside the hydrogen decrepitation furnace is ≤P+75 kPa;
(3) opening the second valve, the third valve, and the fourth valve to allow hydrogen in the hydrogen decrepitation furnace to enter the solid hydrogen-storage device through the first hydrogen recovery pipeline after the hydrogen absorption of the hydrogen decrepitation material is completed, and closing the second valve, the third valve, and the fourth valve while heating the hydrogen decrepitation furnace when the first pressure detection device detects a pressure ≤P+30 kPa; and
opening, when the temperature inside the hydrogen decrepitation furnace is 400-700° C., the fifth valve, the Roots pump, the screw pump, the sixth valve, the third valve, and the fourth valve to allow hydrogen to enter the solid hydrogen-storage device through the first hydrogen recovery pipeline where the first valve is located, the second hydrogen recovery pipeline, and the first hydrogen recovery pipeline where the third and fourth valves are located, and after 5-10 hours, stopping heating the hydrogen decrepitation furnace and closing the first valve, the fifth valve, the Roots pump, the screw pump, the sixth valve, the third valve, and the fourth valve to stop hydrogen recovery; and
(4) opening, after the hydrogen recovery is stopped, the fourteenth valve and the first valve to allow the inert gas to enter the hydrogen decrepitation furnace through the inert gas pipeline, closing the fourteenth valve when the first pressure detection device detects a pressure of P+10 kPa to P+30 kPa inside the hydrogen decrepitation furnace, and when the pressure inside the hydrogen decrepitation furnace decreases to be equal to or less than P-as a result of the hydrogen decrepitation material inside the hydrogen decrepitation furnace gradually cooling and the pressure inside it continuing to drop, opening the fourteenth valve to introduce the inert gas into the hydrogen decrepitation furnace and maintain the pressure inside the hydrogen decrepitation furnace at P to P+30 kPa until the hydrogen decrepitation material in the hydrogen decrepitation furnace cools to ambient temperature.

P herein represents atmospheric pressure.

The hydrogen decrepitation apparatus of the present disclosure enables hydrogen used in hydrogen decrepitation to be reused, reducing costs of hydrogen decrepitation and lowering energy waste. Furthermore, the hydrogen decrepitation apparatus of the present disclosure exhibits high safety.

### BRIEF SUMMARY OF THE DRAWINGS

FIG. 1 is a schematic structural diagram of a hydrogen decrepitation apparatus according to the present disclosure.

Reference numerals of the components are as follows:

1—hydrogen decrepitation furnace; 2—solid hydrogen-storage device; 3—first hydrogen recovery pipeline; 301—first valve; 302—first pressure detection device; 303—second valve; 304—flow meter; 305—third valve; 306—fourth valve; 4—second hydrogen recovery pipeline; 401—fifth valve; 402—Roots pump; 403—screw pump; 404—sixth valve; 5—first discharge pipe; 501—twelfth valve; 6—second discharge pipe; 601—tenth valve; 71—first hydrogen reuse pipeline; 711—seventh valve; 712—pressure reduction valve; 713—second pressure detection device; 72—second hydrogen reuse pipeline; 721—eighth valve; 722—ninth valve; 8—inert gas pipeline; 801—fourteenth valve; 9—external hydrogen pipeline; 901—thirteenth valve; 10—bypass pipeline; 1001—eleventh valve; 1002—vacuum pump; 111—second storage tank; 112-first storage tank; 113—heat exchanger; 114—first liquid input pipeline; 1141—first thermometer; 1142—liquid convey pump; 1143—third control valve; 115—second liquid input pipeline; 116—liquid output pipeline; 1161—second thermometer; 1162—fourth control valve; 117—first connection pipeline; 1171—first control valve; 118—second connection pipeline; 1181—second control valve.

### DETAIL DESCRIPTION OF THE DISCLOSURE

The following is a further description of the present disclosure by means of embodiments, but the present disclosure is not limited to those embodiments.

In the present disclosure, the term “high pressure” refers to a pressure higher than atmospheric pressure.

In the present disclosure, the term “low pressure” refers to a pressure lower than or equal to atmospheric pressure.

### Hydrogen Decrepitation Apparatus

The hydrogen decrepitation apparatus of the present disclosure comprises a hydrogen decrepitation furnace, a solid hydrogen-storage device, a first hydrogen recovery pipeline, a second hydrogen recovery pipeline, a hydrogen reuse pipeline, a first discharge pipe, a second discharge pipe, an inert gas pipeline, and a bypass pipeline. In some embodiments, it further comprises one or more of an external hydrogen pipeline and a liquid heat-exchange device. The structure of each component is described in detail below.

### Hydrogen Decrepitation Furnace

The hydrogen decrepitation furnace of the present disclosure is provided with a hydrogen decrepitation furnace port. The hydrogen decrepitation furnace port is configured to allow a gas to enter or exit the hydrogen decrepitation furnace. The hydrogen decrepitation furnace port can be arranged at the top of the hydrogen decrepitation furnace.

### Solid Hydrogen-Storage Device

The solid hydrogen-storage device of the present disclosure is provided with a solid hydrogen-storage device port. The solid hydrogen-storage device port is configured to allow hydrogen to enter or exit the solid hydrogen-storage device.

The solid hydrogen-storage device can be further provided with a circulation liquid inlet and a circulation liquid outlet. The circulation liquid inlet is configured to allow an endothermic liquid or a heat supply liquid to enter the solid hydrogen-storage device. The circulation liquid outlet is configured to discharge the endothermic liquid or the heat supply liquid from the solid hydrogen-storage device. The solid hydrogen-storage device port and the circulation liquid inlet can be arranged on opposing sides of the solid hydrogen-storage device. The circulation liquid inlet and circulation liquid outlet can be arranged on the same side of the solid hydrogen-storage device.

### First Hydrogen Recovery Pipeline

The first hydrogen recovery pipeline of the present disclosure comprises a first end and a second end away from the first end. The first end of the first hydrogen recovery pipeline is connected to the hydrogen decrepitation furnace port, and the second end of the first hydrogen recovery pipeline is connected to the solid hydrogen-storage device port.

The first hydrogen recovery pipeline is provided, in a direction from the first end to the second end, with a first valve, a first pressure detection device, a flow meter, and a fourth valve in this order. The first hydrogen recovery pipeline can be further provided with a second valve and/or a third valve.

The first valve is arranged near the hydrogen decrepitation furnace port. The first valve is preferably a pneumatic valve.

The first pressure detection device is configured to detect the pressure inside the hydrogen decrepitation furnace. The first pressure detection device is preferably a pressure sensor.

The flow meter is configured to measure the amount of hydrogen passing through the pipeline between the hydrogen decrepitation furnace and the solid hydrogen-storage device.

The fourth valve is arranged close to the solid hydrogen-storage device. The fourth valve is configured to control the gas in the first hydrogen recovery pipeline such that it flows toward the solid hydrogen-storage device. The fourth valve is preferably a pneumatic valve.

The second valve is arranged between the first pressure detection device and the flow meter. The second valve can be arranged close to the flow meter. The second valve is preferably a pneumatic valve.

The third valve is arranged between the flow meter and the fourth valve. The third valve can be arranged close to the flow meter. The third valve is preferably a pneumatic valve.

### Second Hydrogen Recovery Pipeline

The second hydrogen recovery pipeline of the present disclosure comprises a first end and a second end away from the first end. The first end of the second hydrogen recovery pipeline is connected to the first hydrogen recovery pipeline, the second end of the second hydrogen recovery pipeline is connected to the first hydrogen recovery pipeline, and the point where the first end of the second hydrogen recovery pipeline intersects the first hydrogen recovery pipeline is located between the first end of the first hydrogen recovery pipeline and the point where the second end of the second hydrogen recovery pipeline intersects the first hydrogen recovery pipeline. The first end of the second hydrogen recovery pipeline can be connected to the first hydrogen recovery pipeline that is located between the first pressure detection device and the second valve. The second end of the second hydrogen recovery pipeline can be connected to the first hydrogen recovery pipeline located between the second valve and the flow meter.

The second hydrogen recovery pipeline is provided, in a direction from the first end to the second end, with a Roots pump and a screw pump in this order. The second hydrogen recovery pipeline can be further provided with a fifth valve and/or a sixth valve.

The Roots pump and the screw pump can provide driving force. The Roots pump and the screw pump are configured to draw the gas from the hydrogen decrepitation furnace into the second hydrogen recovery pipeline through the first hydrogen recovery pipeline.

The fifth valve is arranged between the first end of the second hydrogen recovery pipeline and the Roots pump. The fifth valve is configured to control the gas in the first hydrogen recovery pipeline such that it flows toward the second hydrogen recovery pipeline. The fifth valve is preferably a pneumatic valve.

The sixth valve is arranged between the screw pump and the second end of the second hydrogen recovery pipeline. The sixth valve is configured to control hydrogen in the second hydrogen recovery pipeline such that it flows toward the first hydrogen recovery pipeline. The sixth valve is preferably a pneumatic valve.

### First Discharge Pipe

The first discharge pipe of the present disclosure comprises a first end and a second end away from the first end. The first end of the first discharge pipe is connected to the first hydrogen recovery pipeline, and the second end of the first discharge pipe is a free end. The first discharge pipe is configured to discharge a high pressure gas into the atmosphere. The high pressure gas can be a mixture of an inert gas and air, such as a mixture of argon and air.

The point where the first end of the first discharge pipe intersects the first hydrogen recovery pipeline can be located between the point where the first end of the second hydrogen recovery pipeline intersects the first hydrogen recovery pipeline and the second valve. The point where the first end of the first discharge pipe intersects the first hydrogen recovery pipeline can be located between the point where the first end of the second hydrogen reuse pipeline intersects the first hydrogen recovery pipeline and the second valve.

The first discharge pipe can be provided with a twelfth valve. The twelfth valve can be arranged close to the first end of the first discharge pipe. The twelfth valve is configured to control the gas in the first hydrogen recovery pipeline such that it flows toward the first discharge pipe. The twelfth valve is preferably a pneumatic valve.

### Second Discharge Pipe

The second discharge pipe of the present disclosure comprises a first end and a second end away from the first end. The first end of the second discharge pipe is connected to the second hydrogen recovery pipeline located between the screw pump and the second end of the second hydrogen recovery pipeline. The second end of the second discharge pipe is a free end. Preferably, the first end of the second discharge pipe is connected to the second hydrogen recovery pipeline located between the screw pump and the sixth valve. The second discharge pipe is configured to discharge a low pressure gas into the atmosphere. The low pressure gas can be a mixture of an inert gas and air, such as a mixture of argon and air.

The second discharge pipe can be provided with a tenth valve. The tenth valve can be arranged close to the first end of the second discharge pipe. The tenth valve is configured to control the gas in the second hydrogen recovery pipeline such that it flows toward the second discharge pipe. The tenth valve is preferably a pneumatic valve.

### Hydrogen Reuse Pipeline

One end of the hydrogen reuse pipeline of the present disclosure is connectable to the hydrogen decrepitation furnace port, and the other end of the hydrogen reuse pipeline is connectable to the solid hydrogen-storage device port. The hydrogen reuse pipeline is configured to convey hydrogen from the solid hydrogen-storage device to the hydrogen decrepitation furnace.

In some embodiments, the hydrogen reuse pipeline comprises a first hydrogen reuse pipeline and a second hydrogen reuse pipeline.

The first hydrogen reuse pipeline comprises a first end and a second end away from the first end. The first end of the first hydrogen reuse pipeline is connected to the first hydrogen recovery pipeline located between the second valve and the flow meter. The second end of the first hydrogen reuse pipeline is connected to the solid hydrogen-storage device port. Specifically, the second end of the first hydrogen reuse pipeline is connected to the first hydrogen recovery pipeline located between the solid hydrogen-storage device port and the fourth valve.

The first hydrogen reuse pipeline can be provided, in the direction from the first end to the second end, a seventh valve, a pressure reduction valve, and a second pressure detection device in this order.

The seventh valve is configured to control hydrogen in the first hydrogen reuse pipeline such that it flows toward the first hydrogen recovery pipeline. The seventh valve is preferably a pneumatic valve.

The pressure reduction valve is configured to reduce the pressure of hydrogen released from the solid hydrogen-storage device.

The second pressure detection device can be arranged close to the solid hydrogen-storage device. The second pressure detection device is configured to detect the pressure inside the solid hydrogen-storage device. The second pressure detection device is preferably a pressure sensor.

The second hydrogen reuse pipeline comprises a first end and a second end away from the first end. The first end of the second hydrogen reuse pipeline is connected to the first hydrogen recovery pipeline located between the first pressure detection device and the second valve. The second end of the second hydrogen reuse pipeline is connected to the first hydrogen recovery pipeline located between the flow meter and the fourth valve. Preferably, the second end of the second hydrogen reuse pipeline is connected to the first hydrogen recovery pipeline located between the third valve and the fourth valve.

The second hydrogen reuse pipeline can be provided with an eighth valve. The eighth valve can be arranged close to the first end of the second hydrogen reuse pipeline. The eighth valve is configured to control hydrogen in the second hydrogen reuse pipeline such that it flows toward the first hydrogen recovery pipeline. The eighth valve is preferably a pneumatic valve.

The second hydrogen reuse pipeline can be further provided with a ninth valve. The ninth valve can be arranged between the eighth valve and the second end of the second hydrogen reuse pipeline. The point where the first end of the external hydrogen pipeline intersects the second hydrogen reuse pipeline can be located between the eighth valve and the ninth valve. The ninth valve is configured to control hydrogen in the external hydrogen pipeline such that it flows toward the second end of the second hydrogen reuse pipeline. The ninth valve is preferably a pneumatic valve.

### Inert Gas Pipeline

The inert gas pipeline of the present disclosure comprises a first end and a second end away from the first end. The first end of the inert gas pipeline is connected to the first hydrogen recovery pipeline, and the second end of the inert gas pipeline is configured to connect to an inert gas supply device. The inert gas pipeline is configured to convey an inert gas to the hydrogen decrepitation furnace. The inert gas is preferably argon.

The point where the first end of the inert gas pipeline intersects the first hydrogen recovery pipeline can be located between the first pressure detection device and the point where the first end of the second hydrogen reuse pipeline intersects the first hydrogen recovery pipeline. The point where the first end of the inert gas pipeline intersects the first hydrogen recovery pipeline can be located between the first pressure detection device and the point where the first end of the second hydrogen recovery pipeline intersects the first hydrogen recovery pipeline. The second end of the inert gas pipeline is configured to connect to the inert gas supply device. The inert gas is preferably argon.

The inert gas pipeline can be provided with a fourteenth valve. The fourteenth valve is configured to control an inert gas in the inert gas pipeline such that it flows toward the first hydrogen recovery pipeline. The fourteenth valve is preferably a pneumatic valve.

### Bypass Pipeline

The first end of the bypass pipeline in the present disclosure is connected to the second hydrogen recovery pipeline that is located between the screw pump and the point where the first end of the second discharge pipe and the second hydrogen recovery pipeline. The second end of the bypass pipeline is connected to the second discharge pipe. Preferably, the second end of the bypass pipeline is connected to the second discharge pipe located between the second end of the second discharge pipe and the tenth valve.

The bypass pipeline is provided with a vacuum pump. The vacuum pump can be arranged between the eleventh valve and the second end of the bypass pipeline. Alternatively, the vacuum pump can be arranged in the middle section of the bypass pipeline. The vacuum pump is configured to discharge the gas in at least a portion of the second hydrogen recovery pipeline and in at least a portion of the second discharge pipe. Preferably, the vacuum pump is configured to discharge the gas from the second hydrogen recovery pipeline between the screw pump and the sixth valve as well as the gas from the second discharge pipe. After an inert gas is introduced into the hydrogen decrepitation furnace, the mixed gas formed of the inert gas and air that is inside the hydrogen decrepitation furnace will be discharged through the second hydrogen recovery pipeline and the second discharge pipe, with some of the mixed gas remaining in the second hydrogen recovery pipeline and the second discharge pipe. If the remained gas is not discharged, hydrogen drawn from the hydrogen decrepitation furnace will mix with the gas remained in the second hydrogen recovery pipeline and in the second discharge pipe during the low pressure hydrogen recovery, posing an explosion hazard. Also, the mixed gas residue can enter the solid hydrogen-storage device along with the low pressure hydrogen, adversely affecting the service life of the solid hydrogen-storage device.

The bypass pipeline can further be provided with an eleventh valve. The eleventh valve can be arranged close to the first end of the bypass pipeline. The eleventh valve is configured to control the gas in the second hydrogen recovery pipeline such that it flows toward the bypass pipeline. The eleventh valve is preferably a pneumatic valve.

### External Hydrogen Pipeline

The external hydrogen pipeline of the present disclosure comprises a first end and a second end away from the first end. The first end of the external hydrogen pipeline is connected to the second hydrogen reuse pipeline located between the eighth valve and the second end of the second hydrogen reuse pipeline. The second end of the external hydrogen pipeline is configured to connect to a hydrogen supply device. Preferably, the first end of the external hydrogen pipeline is connected to the second hydrogen reuse pipeline located between the eighth valve and the ninth valve.

The external hydrogen pipeline can be provided with a thirteenth valve. The thirteenth valve is configured to control hydrogen in the external hydrogen pipeline such that it flows toward the second hydrogen reuse pipeline. The thirteenth valve is preferably a pneumatic valve.

### Liquid Heat-Exchange Device

The liquid heat-exchange device of the present disclosure is configured to supply a heat-exchange liquid to the solid hydrogen-storage device. The liquid heat-exchange device can comprise a first storage tank, a second storage tank, a heat exchanger, a first liquid input pipeline, a second liquid input pipeline, a liquid output pipeline, a first connection pipeline, and a second connection pipeline.

The second storage tank is configured to store an endothermic liquid. The endothermic liquid refers to a liquid with a temperature lower than that of a solid hydrogen-storage material in the solid hydrogen-storage device. The endothermic liquid can exchange heat with the solid hydrogen-storage material, absorbing its thermal energy. The second storage tank is provided with a second storage tank inlet and a second storage tank outlet. The second storage tank inlet is configured to allow the endothermic liquid to enter the second storage tank. The second storage tank outlet is configured to discharge the endothermic liquid from the second storage tank.

The heat exchanger is provided with a heat source inlet, a cold source inlet, a cold source outlet, and a heat source outlet.

The cold source inlet is configured to allow an external coolant to enter the heat exchanger. The external coolant can be cooling circulation water.

The heat source inlet is configured to allow the endothermic liquid having absorbed heat in the solid hydrogen-storage device to enter the heat exchanger.

The heat source outlet is configured to discharge the endothermic liquid subjected to heat exchange in the heat exchanger from the heat exchanger.

The cold source outlet is configured to discharge the coolant subjected to heat exchange from the heat exchanger.

In the heat exchanger, the external coolant is subjected to heat exchange with the endothermic liquid having absorbed heat, lowering the temperature of the endothermic liquid. The cooled endothermic liquid is discharged from the heat source outlet and returned to the second storage tank for reuse.

The first liquid input pipeline comprises a first end and a second end spaced away from the first end. The first end of the first liquid input pipeline is connected to the circulation liquid inlet. The second end of the first liquid input pipeline is connected to the second storage tank outlet.

The first liquid input pipeline can be further provided with a third control valve. The third control valve is configured to control whether the second storage tank outlet is connected to the circulation liquid inlet. The third control valve can be a butterfly valve.

The first liquid input pipeline can also be provided with a liquid convey pump and/or a first thermometer.

The first thermometer can be arranged near the circulation liquid inlet. The first thermometer is configured to measure the temperature of a liquid in the first liquid input pipeline.

The liquid convey pump can be arranged between the first thermometer and the third control valve. The liquid convey pump is configured to convey a liquid in the first liquid input pipeline to the solid hydrogen-storage device.

The second liquid input pipeline comprises a first end and a second end away from the first end. The first end of the second liquid input pipeline is connected to the second storage tank inlet. The second end of the second liquid input pipeline is connected to the heat source outlet of the heat exchanger.

The liquid output pipeline comprises a first end and a second end away from the first end. The first end of the liquid output pipeline is connected to the circulation liquid outlet. The second end of the liquid output pipeline is connected to the heat source inlet of the heat exchanger.

The liquid output pipeline can be provided with a fourth control valve. The fourth control valve is configured to control whether the circulation liquid outlet is connected to the heat source inlet. The fourth control valve is preferably a butterfly valve.

The liquid output pipeline can further be provided with a second thermometer. The second thermometer can be arranged near the circulation liquid outlet. The second thermometer is configured to measure the temperature of a liquid in the liquid output pipeline.

The first storage tank comprises a first storage tank body and a heating device. The first storage tank body is configured to store a heat supply liquid. The heat supply liquid refers to a liquid with a temperature higher than that of a solid hydrogen-storage material in the solid hydrogen-storage device. The heat supply liquid can exchange heat with the solid hydrogen-storage material, supplying thermal energy to the solid hydrogen-storage material. The first storage tank is provided with a first storage tank inlet and a first storage tank outlet. The heating device is configured to heat the heat supply liquid in the first storage tank body.

The first connection pipeline comprises a first end and a second end away from the first end. The first end of the first connection pipeline is connected to the first storage tank outlet. The second end of the first connection pipeline is connected to the first liquid input pipeline. Specifically, the second end of the first connection pipeline is connected to the first liquid input pipeline located between the circulation liquid inlet and the third control valve. Preferably, the second end of the first connection pipeline is connected to the first liquid input pipeline located between the liquid convey pump and the third control valve.

The first connection pipeline can be provided with a first control valve. The first control valve is configured to control whether the first storage tank outlet is connected to the circulation liquid inlet. The first control valve is preferably a butterfly valve.

The first end of the second connection pipeline is connected to the first storage tank inlet. The second end of the second connection pipeline is connected to the liquid output pipeline. Specifically, the second end of the second connection pipeline is connected to the second liquid output pipeline located between the circulation liquid outlet and the fourth control valve. Preferably, the second end of the second connection pipeline is connected to the second liquid output pipeline located between the second thermometer and the fourth control valve.

The second connection pipeline can be further provided with a second control valve. The second control valve is configured to control whether the first storage tank inlet is connected to the circulation liquid outlet. The second control valve is preferably a butterfly valve.

### Hydrogen Recycling Method

The hydrogen recycling method of the present disclose, using the hydrogen decrepitation apparatus described above, comprises: (1) a leak detection procedure; (2) a hydrogen charge procedure; (3) a hydrogen discharge procedure; and (4) an inert gas charge procedure. These procedures are described in detail below.

### Leak Detection Procedure

The leak detection procedure of the present disclosure comprises: (A) an inert gas charge step; (B) a mixed gas discharge step; and (C) a residual mixed gas discharge step.

Step (A) comprises: opening the fourteenth valve and the first valve to allow an inert gas to enter the hydrogen decrepitation furnace through the inert gas pipeline after placing a hydrogen decrepitation material in the hydrogen decrepitation furnace; closing the fourteenth valve to stop charging the hydrogen decrepitation furnace with the inert gas when the pressure inside the hydrogen decrepitation furnace is P+10 kPa to P+30 kPa, preferably P+18 kPa to P+22 kPa; and determining whether the hydrogen decrepitation furnace leaks using the first pressure detection device.

Step (B) comprises: opening the twelfth valve to discharge the gas (a mixed gas of the inert gas and air) in the hydrogen decrepitation furnace through the first hydrogen recovery pipeline and the first discharge pipe if it is determined that the hydrogen decrepitation furnace does not leak; and when the pressure inside the hydrogen decrepitation furnace is P, closing the twelfth valve and opening the fifth valve, the Roots pump, the screw pump, and tenth valve to discharge the remained gas in the hydrogen decrepitation furnace through the second discharge pipe until the pressure inside the hydrogen decrepitation furnace is ≤1.5 Pa.

Step (C) comprises: closing the fifth valve, the Roots pump, the screw pump, and the tenth valve and opening the eleventh valve and the vacuum pump to discharge the gas in the second hydrogen recovery pipeline located between the screw pump and the sixth valve as well as the gas in the second discharge pipe; and closing the eleventh valve and the vacuum pump. The duration of opening the eleventh valve and the vacuum pump can be 3 to 20 min, preferably 5 to 10 min. In closing the eleventh valve and the vacuum pump, closing the eleventh valve is preferably followed by closing the vacuum pump.

The inert gas in the above steps can be argon.

P in the above steps represents atmospheric pressure.

### Hydrogen Charge Procedure

This procedure comprises: opening the seventh valve, the third valve, the ninth valve, the eighth valve, and the first valve to allow hydrogen released from the solid hydrogen-storage device to enter the hydrogen decrepitation furnace through the first hydrogen reuse pipeline, the first hydrogen recovery pipeline where the flow meter is located, the second hydrogen reuse pipeline, and the first hydrogen recovery pipeline where the first valve is located; and
detecting the pressure inside the hydrogen decrepitation furnace using the first pressure detection device, and repeating the following process until the pressure inside the hydrogen decrepitation furnace stabilizes at P+50 kPa to P+120 kPa, preferably P+70 kPa to P+100 kPa, to complete hydrogen charge: closing the eighth valve to stop charging the hydrogen decrepitation furnace with hydrogen when the pressure inside the hydrogen decrepitation furnace is ≥P+80 kPa, preferably ≥P+100 kPa, and opening the eighth valve to charge the hydrogen decrepitation furnace with hydrogen when the pressure inside the hydrogen decrepitation furnace is ≤P+75 kPa, preferably ≤P+70 kPa.

In some embodiments, the hydrogen charge procedure further comprises: charging the hydrogen decrepitation furnace with hydrogen using an external system when, during hydrogen charge, the flow meter detects an amount of hydrogen to be charged that is equal to the amount of hydrogen in the solid hydrogen-storage device. Specifically, the hydrogen charge procedure further comprises: closing the ninth valve, the third valve, and the seventh valve; opening the thirteen valve and the eighth valve to allow hydrogen in the external system to enter the hydrogen decrepitation furnace; and repeating the following process until the pressure inside the hydrogen decrepitation furnace stabilizes at P+50 kPa to P+120 kPa, preferably P+70 kPa to P+100 kPa, to complete hydrogen charge: closing the eighth valve to stop charging the hydrogen decrepitation furnace with hydrogen when the pressure inside the hydrogen decrepitation furnace is ≥P+80 kPa, preferably ≥P+100 kPa, and opening the eighth valve to charge the hydrogen decrepitation furnace with hydrogen when the pressure inside the hydrogen decrepitation furnace is ≤P+75 kPa, preferably ≤P+70 kPa.

In some embodiments, the hydrogen charge procedure further comprises:
opening the first control valve and the second control valve to allow the heat supply liquid stored in the first storage tank to enter the solid hydrogen-storage device through the first connection pipeline and the first liquid input pipeline in the case of charging the hydrogen decrepitation furnace with hydrogen using the solid hydrogen-storage device. Preferably, under the action of the liquid convey pump, the heat supply liquid enters the solid hydrogen-storage device through the first connection pipeline and the first liquid input pipeline. The heat supply liquid causes a solid hydrogen-storage material in the solid hydrogen-storage device to release hydrogen by supplying thermal energy to the material. After the heat supply is completed, the heat supply liquid is returned to the first storage tank through the liquid output pipeline and the second connection pipeline. This cycle is repeated for the reuse of the heat supply liquid.

Alternatively, the hydrogen charge procedure further comprises: closing the first control valve and the second control valve to stop conveying the heat supply liquid to the solid hydrogen-storage device in the case of charging the hydrogen decrepitation furnace with hydrogen using an external system.

P in the above steps represents atmospheric pressure.

### Hydrogen Discharge Procedure

This procedure comprises: opening the second valve, the third valve, and the fourth valve to allow hydrogen in the hydrogen decrepitation furnace to enter the solid hydrogen-storage device through the first hydrogen recovery pipeline after the hydrogen absorption of the hydrogen decrepitation material is completed, and closing the second valve, the third valve, and the fourth valve while heating the hydrogen decrepitation furnace when the first pressure detection device detects a pressure ≤P+30 kPa, preferably a pressure ≤P+20 kPa; and
when the temperature inside the hydrogen decrepitation furnace is 400-700° C., preferably 500-600° C., opening the fifth valve, the Roots pump, the screw pump, the sixth valve, the third valve, and the fourth valve to allow hydrogen to enter the solid hydrogen-storage device through the first hydrogen recovery pipeline where the first valve is located, the second hydrogen recovery pipeline, and the first hydrogen recovery pipeline where the third and fourth valves are located, and after 5-10 hours, preferably 7-8 hours, stopping heating the hydrogen decrepitation furnace and closing the first valve, the fifth valve, the Roots pump, the screw pump, the sixth valve, the third valve, and the fourth valve to stop hydrogen recovery.

In some embodiments, the hydrogen discharge procedure further comprises:
opening the third control valve and the fourth control valve to allow the endothermic liquid stored in the second storage tank to enter the solid hydrogen-storage device through the first liquid input pipeline when recovering hydrogen using the solid hydrogen storage device. Preferably, under the action of the liquid convey pump, the endothermic liquid enters the solid hydrogen storage device through the first liquid input pipeline. The endothermic liquid carries away the heat generated by the solid hydrogen storage material in the solid hydrogen-storage device when it absorbs hydrogen, thereby cooling it. After the heat absorption is completed, the endothermic liquid enters the heat exchanger through the liquid output pipeline. An external coolant (e.g., cooling circulation water) enters the heat exchanger through the cold source inlet. The endothermic liquid is subjected to heat exchange with the external coolant in the heat exchanger. The cooled endothermic liquid is conveyed to the second storage tank through the second liquid input pipeline. This cycle is repeated for the reuse of the endothermic liquid.

The hydrogen discharge procedure further comprises: closing the third control valve and the fourth control valve to stop conveying the endothermic liquid to the solid hydrogen storage device when stopping recovering hydrogen using the solid hydrogen storage device.

A flow meter can be used to measure the total amount of recovered hydrogen.

P in the above steps represents atmospheric pressure.

### Inert Gas Charge Procedure

This procedure comprises: opening, after the hydrogen recovery is stopped, the fourteenth valve and the first valve to allow the inert gas to enter the hydrogen decrepitation furnace through the inert gas pipeline; closing the fourteenth valve when the first pressure detection device detects a pressure of P+10 kPa to P+30 kPa, preferably P+15 kPa to P+25 kPa, inside the hydrogen decrepitation furnace; and when the pressure inside the hydrogen decrepitation furnace decreases to be equal to or less than P-as a result of the hydrogen decrepitation material inside the hydrogen decrepitation furnace gradually cooling and the pressure inside it continuing to drop, opening the fourteenth valve to introduce the inert gas into the hydrogen decrepitation furnace and maintain the pressure inside the hydrogen decrepitation furnace at P to P+30 kPa, preferably P to P+20 kPa, until the hydrogen decrepitation material in the hydrogen decrepitation furnace cools to ambient temperature (e.g., 20-35° C.).

The inert gas can be argon.

P in the above steps represents atmospheric pressure.

### EXAMPLE 1

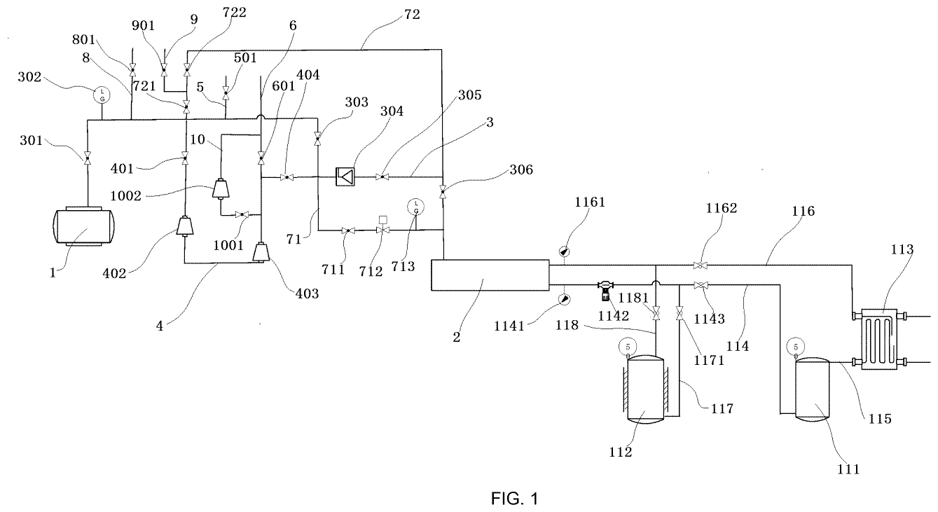

As is shown in FIG. 1, the hydrogen decrepitation apparatus of this example comprised a hydrogen decrepitation furnace 1, a solid hydrogen-storage device 2, a first hydrogen recovery pipeline 3, a second hydrogen recovery pipeline 4, a first discharge pipe 5, a second discharge pipe 6, a hydrogen reuse pipeline, an inert gas pipeline 8, an external hydrogen pipeline 9, a bypass pipeline 10, and a liquid heat-exchange device. In this example, the pressure of hydrogen inside the first hydrogen recovery pipeline 3 was greater than that inside the second hydrogen recovery pipeline 4. The gas pressure inside the first discharge pipe 5 was greater than that inside the second discharge pipe 6.

The hydrogen decrepitation furnace 1 was provided with a hydrogen decrepitation furnace port. The hydrogen decrepitation furnace port was configured to allow a gas to enter or exit the hydrogen decrepitation furnace 1. The hydrogen decrepitation furnace port could be arranged at the top of the hydrogen decrepitation furnace 1.

The solid hydrogen-storage device 2 was provided with a solid hydrogen-storage device port, a circulation liquid inlet, and a circulation liquid outlet. The solid hydrogen-storage device port was configured to allow hydrogen to enter or exit the solid hydrogen-storage device 2. The circulation liquid inlet was configured to allow an endothermic liquid or a heat supply liquid to enter the solid hydrogen-storage device 2. The circulation liquid outlet was configured to discharge the endothermic liquid or the heat supply liquid from the solid hydrogen-storage device 2. The solid hydrogen-storage device port and the circulation liquid inlet were arranged on opposing sides of the solid hydrogen-storage device 2. The circulation liquid inlet and circulation liquid outlet were arranged on the same side of the solid hydrogen-storage device 2.

The first hydrogen recovery pipeline 3 comprised a first end and a second end away from the first end. The first end of the first hydrogen recovery pipeline 3 was connected to the hydrogen decrepitation furnace port, and the second end of the first hydrogen recovery pipeline 3 was connected to the solid hydrogen-storage device port. The first hydrogen recovery pipeline 3 was provided, in the direction from the first end to the second end, with a first valve 301, a first pressure detection device 302, a second valve 303, a flow meter 304, a third valve 305, and a fourth valve 306 in this order.

The first valve 301 was arranged close to the hydrogen decrepitation furnace port. The first valve 301 was preferably a pneumatic valve.

The first pressure detection device 302 was configured to detect the pressure inside the hydrogen decrepitation furnace 1. The first pressure detection device 302 was preferably a pressure sensor.

The second valve 303 was arranged close to the flow meter 304. The second valve 303 was preferably a pneumatic valve.

The flow meter 304 was configured to measure the amount of hydrogen passing through the pipeline between the hydrogen decrepitation furnace 1 and the solid hydrogen-storage device 2.

The third valve 305 was arranged close to flow meter 304. The third valve 305 was preferably a pneumatic valve.

The fourth valve 306 was arranged close to the solid hydrogen-storage device 2 and configured to control the gas in the first hydrogen recovery pipeline 3 such that it flowed toward the solid hydrogen-storage device 2. The fourth valve 306 was preferably a pneumatic valve.

The second hydrogen recovery pipeline 4 comprised a first end and a second end away from the first end. The first end of the second hydrogen recovery pipeline 4 was connected to the first hydrogen recovery pipeline 3 between the first pressure detection device 302 and the second valve 303. The second end of the second hydrogen recovery pipeline 4 was connected to the first hydrogen recovery pipeline 3 between the second valve 303 and the flow meter 304.

The second hydrogen recovery pipeline 4 was provided, in the direction from the first end to the second end, with a fifth valve 401, a Roots pump 402, a screw pump 403, and a sixth valve 404 in this order.

The fifth valve 401 was configured to control the gas in the first hydrogen recovery pipeline 3 such that it flowed toward the second hydrogen recovery pipeline 4. The fifth valve 401 was preferably a pneumatic valve.

The Roots pump 402 and the screw pump 403 provided driving force and were configured to draw the gas from the hydrogen decrepitation furnace 1 into the second hydrogen recovery pipeline 4 through the first hydrogen recovery pipeline 3.

The sixth valve 404 was configured to control hydrogen in the second hydrogen recovery pipeline 4 such that it flowed toward the first hydrogen recovery pipeline 3. The sixth valve 404 was preferably a pneumatic valve.

The hydrogen reuse pipeline included a first hydrogen reuse pipeline 71 and a second hydrogen reuse pipeline 72.

The first hydrogen reuse pipeline 71 comprised a first end and a second end away from the first end. The first end of the first hydrogen reuse pipeline 71 was connected to the first hydrogen recovery pipeline 3 between the second valve 303 and the flow meter 304. The second end of the first hydrogen reuse pipeline 71 was connected the first hydrogen recovery pipeline 3 between the fourth valve 306 and the solid hydrogen-storage device 2.

The first hydrogen reuse pipeline 71 was provided, in the direction from the first end to the second end, a seventh valve 711, a pressure reduction valve 712, and a second pressure detection device 713 in this order.

The seventh valve 711 was configured to control hydrogen in the first hydrogen reuse pipeline 71 such that it flowed toward the first hydrogen recovery pipeline 3. The seventh valve 711 was preferably a pneumatic valve. The pressure reduction valve 712 was configured to reduce the pressure of hydrogen released from the solid hydrogen-storage device 2.

The second pressure detection device 713 was arranged close to the solid hydrogen-storage device 2. The second pressure detection device was configured to detect the pressure inside the solid hydrogen-storage device 2. The second pressure detection device 713 was preferably a pressure sensor.

The second hydrogen reuse pipeline 72 comprised a first end and a second end away from the first end. The first end of the second hydrogen reuse pipeline 72 was connected to the first hydrogen recovery pipeline 3 between the first pressure detection device 302 and the second valve 303. The second end of the second hydrogen reuse pipeline 72 was connected to the first hydrogen recovery pipeline 3 between the third valve 305 and the fourth valve 306.

The second hydrogen reuse pipeline 72 was provided, in the direction from the first and to the second end, with an eighth valve 721 and a ninth valve 722 in this order.

The eighth valve 721 was arranged close to the first end of the second hydrogen reuse pipeline 72. The eighth valve 721 was configured to control hydrogen in the second hydrogen reuse pipeline 72 such that it flowed toward the first hydrogen recovery pipeline 3. The eighth valve 721 was preferably a pneumatic valve.

The ninth valve 722 was arranged close to the eighth valve 721. The ninth valve 722 was configured to control hydrogen in the external hydrogen pipeline 9 such that it flowed toward the second end of the second hydrogen reuse pipeline 72. The ninth valve 722 was preferably a pneumatic valve.

The second discharge pipe 6 comprised a first end and a second end away from the first end. The first end of the second discharge pipe 6 was connected to the second hydrogen recovery pipeline 4 between the screw pump 403 and the sixth valve 404. The second end of the second discharge pipe 6 was a free end. The second discharge pipe 6 was configured to discharge a low pressure gas.

The second discharge pipe 6 was provided with a tenth valve 601. The tenth valve 601 was arranged close to the first end of the second discharge pipe 6. The tenth valve 6 was configured to control the gas in the second hydrogen recovery pipeline 4 such that it flowed toward the second discharge pipe 6. The tenth valve 601 was preferably a pneumatic valve.

The bypass pipeline 10 comprised a first end and a second end away from the first end. The first end of the bypass pipeline 10 was connected to the second hydrogen recovery pipeline 4 between the screw pump 403 and the first end of the second discharge pipe 6. The second end of the bypass pipeline 10 was connected to the second discharge pipe 6 between the second end of the second discharge pipe 6 and the tenth valve 601.

The bypass pipeline 10 was provided, in the direction from the first end to the second end, with an eleventh valve 1001 and a vacuum pump 1002 in this order.

The eleventh valve 1001 was arranged close to the first end of the bypass pipeline 10. The eleventh valve 1001 was configured to control the gas in the second hydrogen recovery pipeline 4 such that it flowed toward the bypass pipeline 10. The eleventh valve 1001 was preferably a pneumatic valve.

The vacuum pump 1002 was arranged between the eleventh valve 1001 and the second end of the bypass pipeline 10. The vacuum pump 1002 could be arranged in the middle section of the bypass pipeline 10. The vacuum pump 1002 was configured to discharge the gas in the second hydrogen recovery pipeline 4 between the screw pump 403 and the sixth valve 404 and the gas in the second discharge pipe 6.

The first discharge pipe 5 comprised a first end and a second end away from the first end. The first end of the first discharge pipe 5 was connected to the first hydrogen recovery pipeline 3, and the point where the first end of the first discharge pipe 5 intersected the first hydrogen recovery pipeline 3 was located not only between the point where the first end of the second hydrogen recovery pipeline 4 intersected the first hydrogen recovery pipeline 3 and the second valve 303 but also between the point where the first end of the second hydrogen reuse pipeline 72 intersected the first hydrogen recovery pipeline 3 and the second valve 303. The second end of the first discharge pipe 5 was a free end.

The first discharge pipe 5 was provided with a twelfth valve 501. The twelfth valve 501 was arranged close to the first end of the first discharge pipe 5. The twelfth valve 501 was configured to control the gas in the first hydrogen recovery pipeline 3 such that it flowed toward the first discharge pipe 5. The twelfth valve 501 was preferably a pneumatic valve.

The external hydrogen pipeline 9 comprised a first end and a second end away from the first end. The first end of the external hydrogen pipeline 9 was connected to the second hydrogen reuse pipeline 72 between the eighth valve 721 and the ninth valve 722. The second end of the external hydrogen pipeline 9 was configured to connect to a hydrogen supply device.

The external hydrogen pipeline 9 was provided with a thirteenth valve 901. The thirteenth valve 901 was configured to control hydrogen in the external hydrogen pipeline 9 such that it flowed toward the second hydrogen reuse pipeline 72. The thirteenth valve 901 was preferably a pneumatic valve.

The inert gas pipeline 8 comprised a first end and a second end away from the first end. The first end of the inert gas pipeline 8 was connected to the first hydrogen recovery pipeline 3, and the point where the first end of the inert gas pipeline 8 intersected the first hydrogen recovery pipeline 3 was located not only between the first pressure detection device 302 and the point where the first end of the second hydrogen reuse pipeline 72 intersected the first hydrogen recovery pipeline 3 but also between the first pressure detection device 302 and the point where the first end of the second hydrogen recovery pipeline 4 intersected the first hydrogen recovery pipeline 3. The second end of the inert gas pipeline 8 was connected to an inert gas supply device. The inert gas was preferably argon.

The inert gas pipeline 8 was provided with a fourteenth valve 801. The fourteenth valve 801 was configured to control an inert gas in the inert gas pipeline 8 such that it flowed toward the first hydrogen recovery pipeline 3. The fourteenth valve 801 was preferably a pneumatic valve.

The liquid heat-exchange device comprised a second storage tank 111, a first storage tank 112, a heat exchanger 113, a first liquid input pipeline 114, a second liquid input pipeline 115, a liquid output pipeline 116, a first connection pipeline 117, and a second connection pipeline 118.

The second storage tank 111 was configured to store an endothermic liquid and provided with a second storage tank inlet and a second storage tank outlet. The endothermic liquid was a liquid with a temperature lower than that of a solid hydrogen-storage material in the solid hydrogen-storage device 2. The second storage tank inlet was configured to allow the endothermic liquid to enter the second storage tank 111. The second storage tank outlet was configured to discharge the endothermic liquid from the second storage tank 111. The second storage tank 111 could be provided with a second storage tank level gauge. The second storage tank level gauge was configured to measure the height of a liquid level inside the second storage tank 111.

The heat exchanger was provided with a heat source inlet, a cold source inlet, a cold source outlet, and a heat source outlet. The cold source inlet was configured to allow an external coolant (e.g., cooling circulation water) to enter the heat exchanger 113. The cold source outlet was configured to discharge the coolant subjected to heat exchange from the heat exchanger 113. The heat source inlet was configured to allow the endothermic liquid having absorbed heat in the solid hydrogen-storage device 2 to enter the heat exchanger 113. The heat source outlet was configured to discharge the endothermic liquid subjected to heat exchange in the heat exchanger 113 from the heat exchanger 113.

The first storage tank 112 comprised a first storage tank body and a heater. The first storage tank body was configured to store a heat supply liquid. The heat supply liquid was a liquid with a temperature higher than that of a solid hydrogen-storage material in the solid hydrogen-storage device 2. The heater was configured to heat the heat supply liquid in the first storage tank body. The first storage tank body was provided with a first storage tank inlet and a first storage tank outlet. The first storage tank 112 could be provided with a first storage tank level gauge. The first storage tank level gauge was configured to measure the height of a liquid level inside the first storage tank 112.

The first liquid input pipeline 114 comprised a first end and a second end spaced away from the first end. The first end of the first liquid input pipeline 114 was connected to the circulation liquid inlet. The second end of the first liquid input pipeline 114 was connected to the second storage tank outlet.

The first liquid input pipeline 114 was provided, in the direction from the first end to the second end, with a first thermometer 1141, a liquid convey pump 1142, and a third control valve 1143 in this order.

The first thermometer 1141 was arranged near the circulation liquid inlet. The first thermometer 1141 was configured to measure the temperature of a liquid in the first liquid input pipeline 114.

The liquid convey pump 1142 provided driving force and was configured to convey a liquid in the first liquid input pipeline 114 to the solid hydrogen-storage device 2.

The third control valve 1143 was configured to control whether the second storage tank outlet is connected to the circulation liquid inlet. The third control valve 1143 was preferably a butterfly valve.

The second liquid input pipeline 115 comprised a first end and a second end away from the first end. The first end of the second liquid input pipeline 115 was connected to the second storage tank inlet. The second end of the second liquid input pipeline 115 was connected to the heat source outlet of the heat exchanger 113.

The liquid output pipeline 116 comprised a first end and a second end away from the first end. The first end of the liquid output pipeline 116 was connected to the circulation liquid outlet. The second end of the liquid output pipeline 116 was connected to the heat source inlet of the heat exchanger 113.

The liquid output pipeline 116 was provided, in the direction from the first end to the second end, with a second thermometer 1161 and a fourth control valve 1162 in this order.

The second thermometer 1161 was arranged near the circulation liquid outlet. The second thermometer 1161 was configured to measure the temperature of a liquid in the liquid output pipeline 116.

The fourth control valve 1162 controlled whether the circulation liquid outlet is connected to the heat source inlet. The fourth control valve 1162 was preferably a butterfly valve.

The first connection pipeline 117 comprised a first end and a second end away from the first end. The first end of the first connection pipeline 117 was connected to the first storage tank outlet. The second end of the first connection pipeline 117 was connected to the first liquid input pipeline 114 between the liquid convey pump 1142 and the third control valve 1143.

The first connection pipeline 117 was provided with a first control valve 1171. The first control valve 1171 controlled whether the first storage tank outlet is connected to the circulation liquid inlet. The first control valve 1171 was preferably a butterfly valve.

The second connection pipeline 118 comprised a first end and a second end away from the first end. The first end of the second connection pipeline 118 was connected to the first storage tank inlet. The second end of the second connection pipeline 118 was connected to the liquid output pipeline 116 between the second thermometer 1161 and the fourth control valve 1162.

The second connection pipeline 118 was provided with a second control valve 1181. The second control valve 1181 controlled whether the first storage tank inlet is connected to the circulation liquid outlet. The second control valve 1181 was preferably a butterfly valve.

### EXAMPLE 2

A hydrogen recycling method using the hydrogen decrepitation apparatus of Example 1 comprised steps described below.
(1) Place a hydrogen decrepitation material (e.g., NdFeB magnet) in the hydrogen decrepitation furnace 1, and open the fourteenth valve 801 and the first valve 301 to allow argon to enter the hydrogen decrepitation furnace 1 through the inert gas pipeline 8. Close the fourteenth valve 801 to stop charging the hydrogen decrepitation furnace 1 with argon when the pressure inside the hydrogen decrepitation furnace 1 was 120 kPa. Determine whether the hydrogen decrepitation furnace 1 leaked using the first pressure detection device 302.

Open the twelfth valve 501 to discharge the mixed gas of argon and air in the hydrogen decrepitation furnace 1 through the first hydrogen recovery pipeline 3 and the first discharge pipe 5 if it was determined that the hydrogen decrepitation furnace 1 did not leak. When the pressure inside the hydrogen decrepitation furnace 1 was 100 kPa, close the twelfth valve 501 and open the fifth valve 401, the Roots pump 402, the screw pump 403, and tenth valve 601 to discharge the mixed gas that remained in the hydrogen decrepitation furnace 1 through the second discharge pipe 6 until the pressure inside the hydrogen decrepitation furnace 1 was ≤1.5 Pa.

Close the fifth valve 401, the Roots pump 402, the screw pump 403, and the tenth valve 601. Open the eleventh valve 1001 and the vacuum pump 1002 to discharge the gas in the second hydrogen recovery pipeline 4 between the screw pump 403 and the sixth valve 404 as well as the gas in the second discharge pipe 6. Close the eleventh valve 1001, and then close the vacuum pump 1002 after the eleventh valve 1001 and the vacuum pump 1002 had been opened for 5 to 10 min.
(2) Open the first control valve 1171 and the second control valve 1181. Under the action of the liquid convey pump 1142, the heat supply liquid stored in the first storage tank 112 was allowed to enter the solid hydrogen-storage device 2 through the first connection pipeline 117 and the first liquid input pipeline 114. The heat supply liquid caused a solid hydrogen-storage material in the solid hydrogen-storage device 2 to release hydrogen by supplying thermal energy to the material. After the heat supply was completed, the heat supply liquid was returned to the first storage tank 112 through the liquid output pipeline 116 and the second connection pipeline 118. This cycle was repeated for the reuse of the heat supply liquid.

Open the seventh valve 711, the third valve 305, the ninth valve 722, the eighth valve 721, and the first valve 301 to allow hydrogen released from the solid hydrogen-storage device 2 to enter the hydrogen decrepitation furnace 1 through the first hydrogen reuse pipeline 71, the first hydrogen recovery pipeline 3 where the flow meter 304 was located, the second hydrogen reuse pipeline 72, and the first hydrogen recovery pipeline 3 where the first valve 301 was located. Detect the pressure inside the hydrogen decrepitation furnace 1 using the first pressure detection device 302. Repeat the following process until the pressure inside the hydrogen decrepitation furnace 1 stabilized at 170-200 kPa to complete hydrogen charge: close the eighth valve 721 to stop charging the hydrogen decrepitation furnace 1 with hydrogen when the pressure inside the hydrogen decrepitation furnace 1 was ≥200 kPa, and open the eighth valve 721 to charge the hydrogen decrepitation furnace 1 with hydrogen when the pressure inside the hydrogen decrepitation furnace 1 was ≤170 kPa.

Charge the hydrogen decrepitation furnace 1 with hydrogen using an external system when, during hydrogen charge, the flow meter 304 detected an amount of hydrogen to be charged that was equal to the amount of hydrogen in the solid hydrogen-storage device 2. Specifically, close the ninth valve 722, the third valve 305, and the seventh valve 711; and close the first control valve 1171 and the second control valve 1181 to stop conveying the heat supply liquid to the solid hydrogen-storage device 2. Open the thirteen valve 901 and the eighth valve 721 to allow hydrogen in the external system to enter the hydrogen decrepitation furnace 1. Repeat the following process until the pressure inside the hydrogen decrepitation furnace 1 stabilized at 170-200 kPa to complete hydrogen charge: close the eighth valve 721 when the pressure inside the hydrogen decrepitation furnace 1 was ≥200 kPa, and open the eighth valve 721 when the pressure inside the hydrogen decrepitation furnace was ≤170 kPa.
(3) Open the third control valve 1143 and the fourth control valve 1162 after the hydrogen absorption of the hydrogen decrepitation material was completed, which, under the action of the liquid convey pump 1142, allowed the endothermic liquid stored in the second storage tank 111 to enter the solid hydrogen-storage device 2 through the first liquid input pipeline 114. The endothermic liquid carried away the heat generated by the solid hydrogen storage material in the solid hydrogen-storage device 2 when it absorbed hydrogen, thereby cooling it. After the heat absorption was completed, the endothermic liquid entered the heat exchanger 113 through the liquid output pipeline 116. An external coolant (e.g., cooling circulation water) entered the heat exchanger 113 through the cold source inlet. The endothermic liquid was subjected to heat exchange with the external coolant in the heat exchanger 113. The cooled endothermic liquid was conveyed to the second storage tank 111 through the second liquid input pipeline 115. This cycle was repeated for the reuse of the endothermic liquid.

Open the second valve 303, the third valve 305, and the fourth valve 306 to allow hydrogen in the hydrogen decrepitation furnace 1 to enter the solid hydrogen-storage device 2 through the first hydrogen recovery pipeline 3. Close the second valve 303, the third valve 305, and the fourth valve 306 while heating the hydrogen decrepitation furnace 1 when the first pressure detection device 302 detected a pressure ≤120 kPa. Open, when the temperature inside the hydrogen decrepitation furnace 1 was 500-600° C., the fifth valve 401, the Roots pump 402, the screw pump 403, the sixth valve 404, the third valve 305, and the fourth valve 306 in this order to allow hydrogen to enter the solid hydrogen-storage device 2 through the first hydrogen recovery pipeline 3 where the first valve 301 was located, the second hydrogen recovery pipeline 4, and the first hydrogen recovery pipeline 3 where the third valve 305 and the fourth valve 306 were located. After 7-8 hours, stop heating the hydrogen decrepitation furnace 1. Close the first valve 301, the fifth valve 401, the Roots pump 402, the screw pump 403, the sixth valve 404, the third valve 305, and the fourth valve 306 to stop hydrogen recovery. Close the third control valve 1143 and the fourth control valve 1162 to stop conveying the endothermic liquid to the solid hydrogen storage device 2. The flow meter 302 measured the total amount of recovered hydrogen.
(4) Open, after the hydrogen recovery was stopped, the fourteenth valve 801 and the first valve 301 to allow argon to enter the hydrogen decrepitation furnace 1 through the inert gas pipeline 8. Close the fourteenth valve 801 when the first pressure detection device 302 detected a pressure of 120 kPa inside the hydrogen decrepitation furnace 1. When the pressure inside the hydrogen decrepitation furnace 1 decreased to be equal to or less than 100 kPa—as a result of the hydrogen decrepitation material inside the hydrogen decrepitation furnace 1 gradually cooling and the pressure inside it continuing to drop, open the fourteenth valve 801 to introduce argon into the hydrogen decrepitation furnace 1 and maintain the pressure inside the hydrogen decrepitation furnace 1 at 100-120 kPa until the hydrogen decrepitation material in the hydrogen decrepitation furnace 1 cooled to ambient temperature.

The present disclosure is not limited to the embodiments described above. Any variation, improvement, and replacement which do not depart from the essence of the present disclosure and which those skilled in the art are able to think of fall within the scope of the present disclosure.

What is claimed is:

1. A hydrogen decrepitation apparatus, comprising a hydrogen decrepitation furnace, a solid hydrogen-storage device, a first hydrogen recovery pipeline, a second hydrogen recovery pipeline, a hydrogen reuse pipeline, a first discharge pipe, a second discharge pipe, an inert gas pipeline, and a bypass pipeline,
wherein the hydrogen decrepitation furnace is provided with a hydrogen decrepitation furnace port configured to allow a gas to enter or exit the hydrogen decrepitation furnace;
the solid hydrogen-storage device is provided with a solid hydrogen-storage device port configured to allow hydrogen to enter or exit the solid hydrogen-storage device;
the first hydrogen recovery pipeline comprises a first end and a second end away from the first end, wherein the first end of the first hydrogen recovery pipeline is connected to the hydrogen decrepitation furnace port, and the second end of the first hydrogen recovery pipeline is connected to the solid hydrogen-storage device port;
the inert gas pipeline comprises a first end and a second end away from the first end, wherein the first end of the inert gas pipeline is connected to the first hydrogen recovery pipeline, and the second end of the inert gas pipeline is configured to connect to an inert gas supply device;
the first discharge pipe comprises a first end and a second end away from the first end, wherein the first end of the first discharge pipe is connected to the first hydrogen recovery pipeline, and the second end of the first discharge pipe is a free end;
the second hydrogen recovery pipeline comprises a first end and a second end away from the first end, wherein the first end of the second hydrogen recovery pipeline is connected to the first hydrogen recovery pipeline, the second end of the second hydrogen recovery pipeline is connected to the first hydrogen recovery pipeline, and a point where the first end of the second hydrogen recovery pipeline intersects the first hydrogen recovery pipeline is located between the first end of the first hydrogen recovery pipeline and a point where the second end of the second hydrogen recovery pipeline intersects the first hydrogen recovery pipeline; and the second hydrogen recovery pipeline is provided, in a direction from the first end to the second end, with a Roots pump and a screw pump in this order;
the second discharge pipe comprises a first end and a second end away from the first end, wherein the first end of the second discharge pipe is connected to the second hydrogen recovery pipeline located between the screw pump and the second end of the second hydrogen recovery pipeline, and the second end of the second discharge pipe is a free end;
a first end of the bypass pipeline is connected to the second hydrogen recovery pipeline located between the screw pump and a point where the first end of the second discharge pipe intersects the second hydrogen recovery pipeline, and a second end of the bypass pipeline is connected to the second discharge pipe; the bypass pipeline is provided with a vacuum pump configured to discharge a gas in at least a portion of the second hydrogen recovery pipeline and a gas in at least a portion of the second discharge pipe; and
one end of the hydrogen reuse pipeline is connectable to the hydrogen decrepitation furnace port, and another end of the hydrogen reuse pipeline is connectable to the solid hydrogen-storage device port; the hydrogen reuse pipeline is configured to convey hydrogen from the solid hydrogen-storage device to the hydrogen decrepitation furnace.

2. The hydrogen decrepitation apparatus according to claim 1, wherein the first hydrogen recovery pipeline is provided, in a direction from the first end to the second end, with a first valve, a first pressure detection device, a flow meter, and a fourth valve in this order,
wherein the first valve is arranged near the hydrogen decrepitation furnace port;
the first pressure detection device is configured to detect a pressure inside the hydrogen decrepitation furnace;
the flow meter is configured to measure the amount of hydrogen passing through a pipeline between the hydrogen decrepitation furnace and the solid hydrogen-storage device; and
the fourth valve is configured to control a gas in the first hydrogen recovery pipeline such that it flows toward the solid hydrogen-storage device.

3. The hydrogen decrepitation apparatus according to claim 2, wherein the first hydrogen recovery pipeline is further provided with a second valve arranged between the first pressure detection device and the flow meter,
wherein the first end of the second hydrogen recovery pipeline is connected to the first hydrogen recovery pipeline located between the first pressure detection device and the second valve, and the second end of the second hydrogen recovery pipeline is connected to the first hydrogen recovery pipeline located between the second valve and the flow meter; and
the second hydrogen recovery pipeline is provided with a fifth valve and a sixth valve,
wherein the fifth valve is arranged between the first end of the second hydrogen recovery pipeline and the Roots pump, and the sixth valve is arranged between the screw pump and the second end of the second hydrogen recovery pipeline.

4. The hydrogen decrepitation apparatus according to claim 3, wherein the hydrogen reuse pipeline comprises a first hydrogen reuse pipeline and a second hydrogen reuse pipeline,
wherein a first end of the first hydrogen reuse pipeline is connected to the first hydrogen recovery pipeline located between the second valve and the flow meter, and a second end of the first hydrogen reuse pipeline is connected to the solid hydrogen-storage device port; and
a first end of the second hydrogen reuse pipeline is connected to the first hydrogen recovery pipeline located between the first pressure detection device and the second valve, and a second end of the second hydrogen reuse pipeline is connected to the first hydrogen recovery pipeline located between the flow meter and the fourth valve.

5. The hydrogen decrepitation apparatus according to claim 4, wherein the first end of the second discharge pipe is connected to the second hydrogen recovery pipeline located between the screw pump and the sixth valve;
the second discharge pipe is provided with a tenth valve,
wherein the second end of the bypass pipeline is connected to the second discharge pipe between the tenth valve and the second end of the second discharge pipe; and
the bypass pipeline is provided with an eleventh valve arranged between the vacuum pump and the first end of the bypass pipeline.

6. The hydrogen decrepitation apparatus according to claim 5, wherein the first hydrogen reuse pipeline is provided, from the first end to the second end, with a seventh valve, a pressure reduction valve, and a second pressure detection device in this order,
wherein the pressure reduction valve is configured to reduce a pressure of hydrogen released from the solid hydrogen-storage device;
the second pressure detection device is configured to detect a pressure inside the solid hydrogen-storage device; and
the second hydrogen reuse pipeline is provided with an eighth valve arranged close to the first end of the second hydrogen reuse pipeline.

7. The hydrogen decrepitation apparatus according to claim 6, further comprising an external hydrogen pipeline,
wherein the external hydrogen pipeline comprises a first end and a second end away from the first end, wherein the first end of the external hydrogen pipeline is connected to the second hydrogen reuse pipeline located between the eighth valve and the second end of the second hydrogen reuse pipeline, and the second end of the external hydrogen pipeline is configured to connect to a hydrogen supply device; and
the second hydrogen reuse pipeline is provided with a ninth valve arranged between a point where the first end of the external hydrogen pipeline intersects the second hydrogen reuse pipeline and the second end of the second hydrogen reuse pipeline.

8. The hydrogen decrepitation apparatus according to claim 7, wherein the first end of the inert gas pipeline is connected to the first hydrogen recovery pipeline located between the first pressure detection device and a point where the first end of the second hydrogen recovery pipeline intersects the first hydrogen recovery pipeline; the inert gas pipeline is provided with a fourteenth valve; and
the external hydrogen pipeline is provided with a thirteenth valve.

9. The hydrogen decrepitation apparatus according to claim 8, further comprising: a liquid heat-exchange device, wherein the solid hydrogen-storage device is further provided with a circulation liquid inlet and a circulation liquid outlet; and
the liquid heat-exchange device comprises a first storage tank, a second storage tank, a heat exchanger, a first liquid input pipeline, a second liquid input pipeline, a liquid output pipeline, a first connection pipeline, and a second connection pipeline,
wherein the second storage tank is configured to store a endothermic liquid and provided with a second storage tank inlet and a second storage tank outlet,
the heat exchanger is provided with a heat source inlet, a cold source inlet, a cold source outlet, and a heat source outlet, wherein the cold source inlet is configured to allow an external coolant to enter the heat exchanger, the heat source inlet is configured to allow the endothermic liquid having absorbed heat in the solid hydrogen-storage device to enter the heat exchanger, the heat source outlet is configured to discharge the endothermic liquid subjected to heat exchange in the heat exchanger from the heat exchanger, and the cold source outlet is configured to discharge the coolant subjected to heat exchange from the heat exchanger,
the first liquid input pipeline comprises a first end and a second end spaced away from the first end, wherein the first end of the first liquid input pipeline is connected to the circulation liquid inlet, and the second end of the first liquid input pipeline is connected to the second storage tank outlet,
the second liquid input pipeline comprises a first end and a second end away from the first end, wherein the first end of the second liquid input pipeline is connected to the second storage tank inlet, and the second end of the second liquid input pipeline is connected to the heat source outlet of the heat exchanger,
the liquid output pipeline comprises a first end and a second end away from the first end, wherein the first end of the liquid output pipeline is connected to the circulation liquid outlet, and the second end of the liquid output pipeline is connected to the heat source inlet of the heat exchanger,
the first storage tank comprises a first storage tank body and a heating device, wherein the first storage tank body is configured to store a heat supply liquid and provided with a first storage tank inlet and a first storage tank outlet, and the heating device is configured to heat the heat supply liquid in the first storage tank body,
the first connection pipeline comprises a first end and a second end away from the first end, wherein the first end of the first connection pipeline is connected to the first storage tank outlet, and the second end of the first connection pipeline is connected to the first liquid input pipeline, and
the second connection pipeline comprises a first end and a second end away from the first end, wherein the first end of the second connection pipeline is connected to the first storage tank inlet, and the second end of the second connection pipeline is connected to the liquid output pipeline.

10. A hydrogen recycling method using the hydrogen decrepitation apparatus according to claim 8, comprising:
(1) opening the fourteenth valve and the first valve to allow an inert gas to enter the hydrogen decrepitation furnace through the inert gas pipeline after placing a hydrogen decrepitation material in the hydrogen decrepitation furnace, closing the fourteenth valve to stop charging the hydrogen decrepitation furnace with the inert gas when the pressure inside the hydrogen decrepitation furnace is P+10 kPa to P+30 kPa, and determining whether the hydrogen decrepitation furnace leaks using the first pressure detection device;
opening the twelfth valve to discharge the gas in the hydrogen decrepitation furnace through the first hydrogen recovery pipeline and the first discharge pipe if it is determined that the hydrogen decrepitation furnace does not leak, and when the pressure inside the hydrogen decrepitation furnace is P, closing the twelfth valve and opening the fifth valve, the Roots pump, the screw pump, and tenth valve to discharge the remained gas in the hydrogen decrepitation furnace through the second discharge pipe until the pressure inside the hydrogen decrepitation furnace is ≤1.5 Pa; and
closing the fifth valve, the Roots pump, the screw pump, and the tenth valve and opening the eleventh valve and the vacuum pump to discharge the gas in the second hydrogen recovery pipeline located between the screw pump and the sixth valve as well as the gas in the second discharge pipe, and closing the eleventh valve and the vacuum pump;
(2) opening the seventh valve, the third valve, the ninth valve, the eighth valve, and the first valve to allow hydrogen released from the solid hydrogen-storage device to enter the hydrogen decrepitation furnace through the first hydrogen reuse pipeline, the first hydrogen recovery pipeline where the flow meter is located, the second hydrogen reuse pipeline, and the first hydrogen recovery pipeline where the first valve is located; and
detecting the pressure inside the hydrogen decrepitation furnace using the first pressure detection device, and repeating the following process until the pressure inside the hydrogen decrepitation furnace stabilizes at P+50 kPa to P+120 kPa, to complete hydrogen charge: closing the eighth valve to stop charging the hydrogen decrepitation furnace with hydrogen when the pressure inside the hydrogen decrepitation furnace is ≥P+80 kPa, and opening the eighth valve to charge the hydrogen decrepitation furnace with hydrogen when the pressure inside the hydrogen decrepitation furnace is ≤P+75 kPa;
(3) opening the second valve, the third valve, and the fourth valve to allow hydrogen in the hydrogen decrepitation furnace to enter the solid hydrogen-storage device through the first hydrogen recovery pipeline after the hydrogen absorption of the hydrogen decrepitation material is completed, and closing the second valve, the third valve, and the fourth valve while heating the hydrogen decrepitation furnace when the first pressure detection device detects a pressure ≤P+30 kPa; and
opening, when the temperature inside the hydrogen decrepitation furnace is 400-700° C., the fifth valve, the Roots pump, the screw pump, the sixth valve, the third valve, and the fourth valve to allow hydrogen to enter the solid hydrogen-storage device through the first hydrogen recovery pipeline where the first valve is located, the second hydrogen recovery pipeline, and the first hydrogen recovery pipeline where the third and fourth valves are located, and after 5-10 hours, stopping heating the hydrogen decrepitation furnace and closing the first valve, the fifth valve, the Roots pump, the screw pump, the sixth valve, the third valve, and the fourth valve to stop hydrogen recovery; and
(4) opening, after the hydrogen recovery is stopped, the fourteenth valve and the first valve to allow the inert gas to enter the hydrogen decrepitation furnace through the inert gas pipeline, closing the fourteenth valve when the first pressure detection device detects a pressure of P+10 kPa to P+30 kPa inside the hydrogen decrepitation furnace, and when the pressure inside the hydrogen decrepitation furnace decreases to be equal to or less than P-as a result of the hydrogen decrepitation material inside the hydrogen decrepitation furnace gradually cooling and the pressure inside it continuing to drop, opening the fourteenth valve to introduce the inert gas into the hydrogen decrepitation furnace and maintain the pressure inside the hydrogen decrepitation furnace at P to P+30 kPa until the hydrogen decrepitation material in the hydrogen decrepitation furnace cools to ambient temperature,
wherein P represents atmospheric pressure.
